(19) United States
(12) Patent Application Publication
(10) Pub. No.: US 2026/0221474 A1
(43) Pub. Date: Jul. 30, 2026

(54) TURBINE

(71) Applicant: Wuxi Cummins Turbo Technologies Company Ltd., Jiangsu (CN)

(72) Inventor: Yangli SUN, Jiangsu (CN)

(21) Appl. No.: 19/143,272

(22) PCT Filed: Dec. 27, 2023
(86) PCT No.: PCT/CN2023/142282

§ 371 Date: Jun. 25, 2025

(30) Foreign Application Priority Data
Dec. 28, 2022 (CN) 202211743250.5

(51) Int. Cl. H01M 8/04111; F04D 17/10; F04D 29/44; H01M 8/04007; H01M 8/04119

(52) U.S. Cl. CPC H01M 8/04111; F04D 17/10; F04D 29/444; H01M 8/04067; H01M 8/04126; H01M 2250/20

(57) ABSTRACT

A compressor housing (4) having a humidification arrangement (32) configured to increase the humidity of compressed gas in a fuel cell system, a compressor housing assembly comprising the same, and a method of compressing and humidifying a gas in a fuel cell system are disclosed. The compressor housing (4) comprises an inlet portion (12) defining a compressor inlet (14) configured 2024/140782 to receive intake air, an impeller chamber portion at least partially defining an impeller chamber (18) in fluid communication with the compressor inlet (14), and an outlet portion (20) at least partially defining a compressor outlet (22) in fluid communication with the impeller chamber (18). The outlet portion (20) at least partially defines a humidification arrangement (32) configured to deliver a humidification liquid to the compressor outlet (22).

### CROSS-REFERENCE TO RELATED APPLICATION

This application is a US national stage of and claims the priority benefit of International Patent Application No. PCT/CN2023/142282, Dec. 27, 2023, which claims priority to Chinese Patent Application No. 202211743250.5, filed Dec. 28, 2022, the entire contents and disclosures of which are incorporated herein by reference.

### TECHNICAL FIELD

The present invention relates to a compressor housing having a humidification arrangement configured to increase the humidity of compressed gas in a fuel cell system, a compressor housing assembly comprising the same, and a method of compressing and humidifying a gas in a fuel cell system.

### BACKGROUND

Internal combustion engines have been used for many years to produce power to drive machinery and vehicles. The pollutants produced by such internal combustion engines have been found to have a harmful impact on the environment, and in particular are known to contribute to the climatological phenomena that cause climate change. For many decades, much research and development has focussed on reducing pollutants from internal combustion engines to minimise their environmental impact. Whilst considerable progress has been made to reduce the production of pollutants in this regard, unfortunately it is impossible to entirely eliminate the production of pollutants during the process of combustion. Accordingly, it is widely recognised that there is a need to develop alternative sources of power that do not produce such pollutants.

Fuel cells are alternative sources of power to internal combustion engines. Fuel cells generate electricity by combining a fuel with an oxidant. The electricity generated by such fuel cells can be used for any electrical purpose, for example to power homes and electronic devices, as well as being used to power machinery and vehicles via the use of electric motors. Typically, the fuel employed in such fuel cells is Hydrogen (H₂), however alkanes such as Methane (CH₄) or alcohols such as Methanol (CH₃OH) can be used instead. Likewise, Oxygen (O₂) is typically used as the oxidant, however any oxygen-containing gas mixture, such as atmospheric air (a mixture of Nitrogen N₂ and Oxygen O₂) may be used as an alternative.

Proton-exchange membrane (PEM) fuel cells, also called polymer electrolyte membrane fuel cells, are a type of fuel cell that is often used for vehicular propulsion. PEM fuel cells comprise an anode and a cathode separated by a polymer electrolyte membrane in a layered structure. The anode and cathode are connected to one another via an electrical load. During use, Hydrogen (the fuel) is delivered to the anode side of the cell and atmospheric air (the oxidant) is delivered to the cathode side of the cell. The anode is provided with a platinum catalyst which acts to reduce the Hydrogen so that it is positively charged, by “stripping” it of its single electron. The Hydrogen ions and electrons formed at the catalyst are able to react with the Oxygen component of the air to which the cathode is exposed, and are thereby attracted to the Oxygen by their electrical charges. In order to reach the Oxygen, the Hydrogen ions take a direct path from the anode side to the cathode side of the cell by permeating through the polymer electrolyte membrane. However, the polymer electrolyte membrane is configured to exclude the passage of electrons therethrough. Unable to pass through the membrane, the electrons pass from the anode to the cathode via the attached electrical load, thereby producing electrical power that can be extracted for useful purposes. Once the Hydrogen ions and electrons reach the cathode, both react with the Oxygen component of the air to which the cathode is exposed, thus creating water (H₂O).

The efficiency of the transmission of Hydrogen ions through the membrane is affected by a number of factors, including the material of the membrane, the thickness of the membrane, and the activity of water at the membrane surface. It has been found that for optimised efficiency, the humidity of the air provided to the cathode side of the cell should be controlled. If the membrane is too dry, internal resistance to Hydrogen ion transmission increases (known as membrane “dry out”). If the membrane is too wet, surface water may act to block the membrane, preventing the passage of Hydrogen ions (known as membrane “flooding”). The degree of humidity required for optimum performance will be dependent upon the material and physical properties of the membrane itself, however optimum performance often occurs in the range of 20% to 70% relative humidity. Depending upon geographical location, atmospheric air often is often humid, and therefore the use of atmospheric air as the oxidant (rather than pure Oxygen) can mitigate against membrane “dry out”.

In PEM fuel cells of the kind described above, the Hydrogen is typically supplied from a high pressure storage tank and therefore further compression of the Hydrogen before delivery to the anode side of the cell is unnecessary. However, the pressure of the atmospheric air supplied to the cathode side of the cell may be increased by using a compressor. By increasing the pressure of the intake air, the mass of Oxygen within the cathode chamber can be increased. With more Oxygen available at the cathode, a greater number of combination reactions on the cathode side can be supported, leading to higher electrical potential across the cell and the production of more power.

The saturation pressure of a gas is representative of the liquid-holding capacity of the gas, and typically increases with increasing temperature. When the intake air is compressed the temperature of the intake air increases, and therefore the saturation pressure of the water vapour within the compressed intake air also increases. However, the saturation pressure of the water vapour in the compressed intake air increases at a faster rate than the corresponding increase in vapour pressure caused by the compressor. Because the water-holding capacity of the compressed air has increased but the mass of water vapour suspended in the air remains the same, this results in a decrease in the relative humidity of the compressed intake air. Without further control, this decrease in relative humidity may cause the fuel cell to be exposed to so-called membrane “dry out” conditions.

In order to mitigate against membrane “dry out” in compressed fuel cell systems, it is known to process the compressed air through a heat exchanger to reduce its temperature. Reducing the temperature of the compressed intake air reduces its saturation pressure and thereby increases relative humidity. However, the thermal exchange required to reduce the temperature of the compressed intake air to a sufficient degree that the relative humidity falls within the optimised working range is typically large. Such a large thermal exchange requires a large heat exchanger, which is often impractical for vehicular use. Accordingly, many fuel cell systems in vehicles are provided with heat exchangers that are unable to reduce the temperature of the compressed intake air to a sufficient degree that the relative humidity falls within the optimised working range.

To further mitigate against this problem, it is known to provide such fuel cell systems with a humidifier positioned downstream of the heat exchanger. Such humidifiers typically comprise an array of water-permeable tubes through which the dry compressed air is channelled. Humid air comprising a high concentration of water vapour that has been produced in the cathode chamber of the fuel cell is passed around the outsides of the tubes. The water vapour diffuses through the tube walls, thus humidifying the compressed intake air. Accordingly, the humidity of the compressed intake air can be controlled so as to optimise the performance of the fuel cell.

Whilst such humidifiers are an effective solution for controlling humidity to optimise fuel cell performance, the permeable tubes employed in such humidifiers require a relatively large surface area in order to effectively diffuse water therethrough. Consequently such humidifiers are typically large and bulky in construction. This makes the use of such humidifiers undesirable in spatially-constrained applications, such as for example in vehicles.

It is an object of the present invention to provide humidification to a fuel cell system that obviates the need for large and bulky prior art humidifiers. It is a further object of the invention obviate or mitigate one or more problems associated with the prior art, whether identified herein or elsewhere. It is a final object of the invention to provide an alternative humidification arrangement for a fuel cell system.

According to a first aspect of the invention, there is provided a compressor housing for a compressor of a fuel cell system, the compressor housing comprising:
an inlet portion defining a compressor inlet configured to receive intake air,
an impeller chamber portion at least partially defining an impeller chamber in fluid communication with the compressor inlet; and
an outlet portion at least partially defining a compressor outlet in fluid communication with the impeller chamber;
wherein the outlet portion at least partially defines a humidification arrangement configured to deliver a humidification liquid to the compressor outlet.

Because the compressor housing at least partially defines the humidification arrangement, the humidification arrangement is partially or entirely integrated into the compressor housing. Accordingly, the compressor within which the housing is used is operable to provide humidification. This may avoid the need for a separate secondary humidifier elsewhere in the fuel cell system, thereby leading to cost and space savings. Alternatively, if a secondary humidifier is required, the humidification arrangement of the compressor housing will reduce the humidification requirement of the secondary humidifier, thus enabling it to be reduced in size and thereby leading to cost and space savings.

Moreover, because the humidification arrangement is defined at least in part by the outlet portion of the compressor housing, this ensures that humidification takes place where the pressure and velocity of the intake air are highest. By performing humidification within the high pressure and high velocity conditions of the outlet portion, this helps to ensure good entrainment of the humidification liquid, which may be water or another substance, within the compressed intake air. Additionally, this may help to distribute the humidification liquid more evenly throughout the intake air and therefore promote enhanced flow uniformity.

Positioning the humidification arrangement in the outlet portion of the compressor housing also ensures that the humidification takes place downstream of the compressor chamber. As a result, this reduces that chance that humid air will leak from the compressor chamber to the bearing housing containing the bearings that support the compressor for rotation. Ingress of humidity into the bearing housing may cause oxidation of the bearing components (i.e. the formation of rust), or, if humidity is excessive, flooding of the bearing housing with water. However, such risks are almost entirely avoided when the humidification takes placed downstream of the compressor chamber.

Finally, the temperature of the humidification liquid is generally ambient, and is therefore lower than the temperature of the compressed intake air which has increased significantly due to compression. By humidifying the intake air in the compressor outlet, the temperature of the intake air is reduced, causing a corresponding reduction in the saturation pressure of the intake air and a rise in relative humidity. Accordingly, the compressor housing offers improved control over the humidity of the intake air provided to the fuel cell.

In this context, a “compressor housing” encompasses a singular body or assembly of bodies at least partially defining the geometry of a compressor.

The “inlet portion” encompasses the part of the compressor housing that defines the compressor inlet. The compressor inlet may receive intake air from an intake system, for example comprising a particulate filter or the like.

The “impeller portion” encompasses the part of the compressor housing that defines the impeller chamber. The impeller chamber encompasses the part of the compressor that contains the impeller (i.e. compressor wheel), within which the impeller is supported for rotation. The impeller chamber may be defined by the impeller portion of the compressor housing in combination with other components of the compressor, for example a compressor back plate.

The “outlet portion” encompasses the part of the compressor housing that defines the compressor outlet. The compressor outlet encompasses the part of the compressor that receives intake air that has been compressed by the impeller. Accordingly, the compressor outlet may be described as being downstream of the impeller chamber and the compressor inlet. The compressor outlet may be defined by the outlet portion of the compressor housing in combination with other components of the compressor, for example the compressor back plate.

The “humidification arrangement” encompasses a part of the outlet portion that wholly or partially defines a structure that is configured, during use, to introduce fluid into the compressed intake air in the compressor outlet, such that the fluid becomes entrained within and carried away by the intake air. The humidification arrangement may be defined wholly by the compressor housing, or may be defined partially by the compressor housing in combination with other components of the compressor, for example: dosing modules, removable covering elements, nozzles or the like.

The outlet portion of the compressor housing may at least partially define a diffuser portion in communication with the impeller chamber, and the diffuser portion may at least partially define the humidification arrangement.

The “diffuser portion” encompasses a sub-region of the outlet portion of the compressor housing. The diffuser may be a portion of the compressor immediately downstream of the impeller. In the diffuser portion the intake air is diffused so that the static pressure of the intake air is increased in accordance with the Bernoulli principle. As such, the intake air passing through the diffuser portion is generally high velocity and high pressure, and is therefore able to promote improved entrainment of the humidification liquid within the intake air.

Typically, the diffuser will be defined by an annular passage, however other geometries may be appropriate. The diffuser may be defined by the diffuser portion of the compressor housing in combination with other components of the compressor, for example the compressor back plate. The compressor housing may be formed by an assembly of bodies, at least one of which defines the diffuser portion. The humidification arrangement may be entirely defined by the diffuser portion of the compressor housing.

The humidification arrangement may comprise a manifold defined between the diffuser portion of the compressor housing and a covering element. In alternative embodiments, the covering element may be integrally formed with the compressor housing so as to enclose the channel. Such embodiments may be made possible for example by additive manufacturing.

The compressor housing may comprise a peripherally extending groove having a stepped portion configured to receive the covering element.

In this sense, the term “peripherally extending” encompasses a groove extending around the entire periphery of the shaft axis, however the radial spacing from the shaft axis may be varied. In one embodiment, the groove may be an annular groove.

The humidification arrangement may comprise an inlet in fluid communication with the manifold and configured to receive humidification liquid from an external source.

The compressor housing may define a compressor axis, and the manifold may peripherally surround the compressor axis.

The manifold may be defined by an annular groove centred on the compressor axis.

According to a second aspect of the invention, there is provided a compressor housing assembly comprising:
the compressor housing of the first aspect of the invention; and
a covering element configured for receipt within the channel;
   wherein the covering element comprises a humidification orifice configured to permit fluid communication from the channel to the diffuser.

The covering element may comprise an annular plate configured for receipt within the annular channel. The annular plate may comprise the humidification orifice. The covering element may comprise a plurality of humidification orifices. The plurality of humidification orifices may be equispaced around the compressor axis. However, in alternative embodiments the humidification ports may be unequally spaced about the compressor axis. The covering element may comprise a diffuser vane extending from a base portion of the covering element in an axial direction relative to the compressor axis. The covering element may comprise a plurality of diffuser vanes. The diffuser vane may comprise the humidification orifice. In further embodiments, the diffuser vane may comprise more than one humidification orifice. Where the covering element comprises a plurality of diffuser vanes, each diffuser vane may comprise one or more humidification orifices.

The diffuser vane may comprises a pressure side and a suction side, and the suction side comprises the humidification orifice. During use, the suction side of the vane will be exposed to a region of low pressure that will create a pressure differential assisting extraction of fluid from the humidification arrangement into the compressor via the humidification orifice.

The humidification orifice may be positioned at a point on the diffuser vane in communication with the region of lowest local pressure during use of a compressor within which the compressor housing assembly forms part. The region of lowest local pressure may be at the vane leading edge, and therefore the humidification orifice may be positioned at or close to the vane leading edge, for example within around 25 % of the distance between the leading and trailing edges. Because the humidification orifice is positioned in communication with the region of lowest local pressure, this helps to optimise extraction of fluid through the humidification orifice by maximising the local pressure differential between the fluid in the humidification arrangement and the fluid in the compressor.

The diffuser vane may comprise a pressure side and a suction side, and the pressure side may comprise the humidification orifice. Because the pressure side comprises the humidification orifice, the humidification liquid is delivered to the diffuser passage at a position having relatively high local pressure. This may improve atomisation of the humidification liquid. Alternatively, the humidification orifice may be positioned at a point on the diffuser vane in communication with the region of highest local pressure during use of a compressor within which the compressor housing assembly forms part.

The diffuser vane may define a proximal end and a distal end relative to the base portion, and the humidification orifice may be positioned generally halfway between the proximal and distal ends.

The diffuser vane may define a leading edge and a trailing edge, and the humidification orifice may be positioned generally halfway between the leading edge and the trailing edge. The compressor housing assembly may comprise a dosing module in fluid communication with the inlet.

According to a third aspect of the invention there is provided a compressor comprising the compressor housing of the first aspect of the invention or the compressor housing assembly of the second aspect of the invention.

According to a fourth aspect of the invention, there is provided a fuel cell system comprising:
a fuel cell inlet configured to receive intake air from the atmosphere;
a compressor according to the third aspect of the invention, the compressor inlet being in communication with the fuel cell inlet to receive intake air;
a heat exchanger in communication with the compressor outlet, the heat exchanger being configured to extract heat from the compressed intake air; and
   a fuel cell in communication with the heat exchanger to receive compressed intake air.

The fuel cell may be hydrogen fuel cell, and in particular a proton-exchange membrane (PEM) fuel cell. The fuel cell inlet may be an inlet of the fuel cell that is in fluid communication with the cathode of the fuel cell (i.e. the oxidant side of the fuel cell).

According to a fifth aspect of the invention, there is provided a vehicle comprising the fuel cell system of the fourth aspect of the invention.

According to a sixth aspect of the invention, there is provided a covering element for a humidification arrangement of a compressor housing, the covering element comprising a humidification orifice configured to permit fluid communication from a manifold of the humidification arrangement to a diffuser passage of a compressor of which the compressor housing forms part.

The covering element may comprise an annular plate configured for receipt within an annular groove of the humidification arrangement. The annular plate may comprise the humidification orifice. The covering element may comprise a plurality of humidification orifices. The covering element may defines a central axis, and the plurality of humidification orifices may be equispaced around the central axis.

The covering element may comprise a base portion and a diffuser vane extending from the base portion in an axial direction relative to the central axis. The diffuser vane may comprise the humidification orifice. The diffuser vane may comprise a pressure side and a suction side, and the suction side may comprise the humidification orifice.

The humidification orifice may be positioned at a point on the diffuser vane in communication with the region of lowest local pressure during use of a compressor within which the covering element forms part. The diffuser vane may comprise a pressure side and a suction side, and the pressure side may comprise the humidification orifice.

The diffuser vane may define a proximal end and a distal end relative to the base portion, and the humidification orifice may be positioned generally halfway between the proximal and distal ends.

The diffuser vane may define a leading edge and a trailing edge, and the humidification port may be positioned generally halfway between the leading edge and the trailing edge.

According to a seventh aspect of the invention, there is provided a method of compressing and humidifying a gas in a fuel cell system, the method comprising:
receiving ambient pressure gas at a first pressure into an inlet of a compressor;
compressing the ambient pressure gas using the compressor to a second pressure, higher than the first pressure to produce compressed gas;
delivering a humidification liquid to the compressed gas via a humidification arrangement positioned within an outlet of the compressor to produce humidified compressed gas; and
   delivering the humidified compressed gas to an inlet of a fuel cell.

The compressor may comprise a compressor housing according to the first aspect of the invention, or a compressor housing assembly according to the second aspect of the invention.

### BRIEF DESCRIPTION OF THE DRAWINGS

A detailed description of the invention is set out below with deference to the accompanying drawings in which:

FIG. 1 is a schematic cross-sectional side view of a compressor according to a first embodiment of the present invention;

FIG. 2 is a schematic enlarged sectional view of a portion of the compressor according to the first embodiment of the present invention;

FIG. 3 is a schematic cross-sectional plan view of a portion of the compressor according to the first embodiment of the present invention;

FIG. 4 is a schematic cross-sectional side view of a compressor according to a second embodiment of the present invention;

FIG. 5 is a schematic perspective view of a portion of a covering element for use within the compressor of the second embodiment of the present invention;

FIG. 6 is a schematic flow diagram of a method of compressing and humidifying a gas in a fuel cell system according to the present invention; and

FIG. 7 is a schematic diagram of a fuel cell system according to the present invention.

### DETAILED DESCRIPTION OF THE DRAWINGS

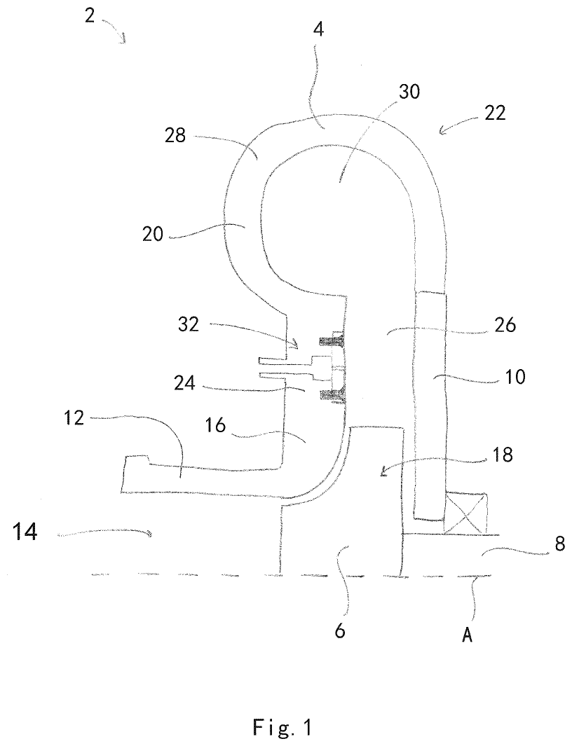

FIG. 1 shows a cross-sectional view of a compressor 2 according to the present invention. The compressor 2 comprises a compressor housing 4, an impeller (compressor wheel) 6 supported by a compressor shaft 8, and a back plate 10. The shaft 8 is supported for rotation about a shaft axis A. The compressor housing 4 comprises an inlet portion 12 defining a compressor inlet 14. The compressor housing 4 further comprises an impeller chamber portion 16 defining an impeller chamber 18 containing the impeller 6. The compressor housing 4 further defines an outlet portion 20 defining a compressor outlet 22. The outlet portion 20 comprises a diffuser portion 24 at least partially defining a generally annular diffuser passage 26 and a volute portion 28 defining an outlet volute 30. Both the diffuser passage 26 and the volute portion 28 are considered to form part of the compressor outlet. Although not shown, the compressor outlet 22 is fluidly connected to the inlet of a fuel cell. During use, the shaft 8 is driven to rotate about the shaft axis A. The shaft 8 may be driven by any suitable power source, such as for example an electric motor, a turbine (for example, in the form of a turbocharger), or a combination of both (for example, in the form of an electrically assisted turbocharger). Rotation of the shaft 8 causes corresponding rotation of the impeller 6 which draws intake air into the compressor inlet 14. The intake air enters the compressor inlet at a first pressure p1, which may be atmospheric pressure. The intake air is drawn into the impeller chamber 18 whereupon it is centrifugally compressed by the blades (not shown) of the impeller 6. Compression of the intake air raises its pressure to a second pressure p2 that is higher than the first pressure p1. The compressed intake air is flung centrifugally outwards away from the shaft axis A along the diffuser passage 26 and into the outlet volute 30. The compressed intake air is passed by the outlet volute 30 to the inlet of the fuel cell.

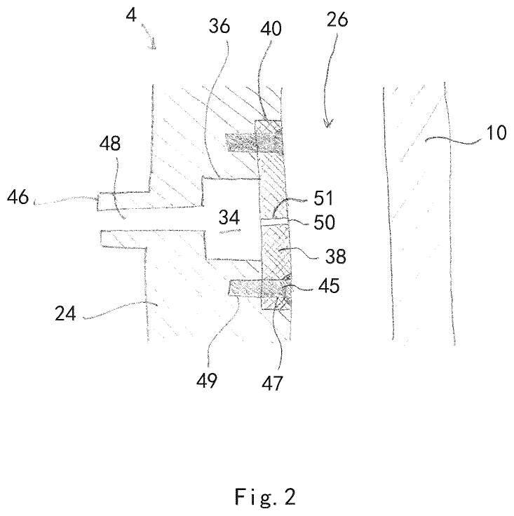

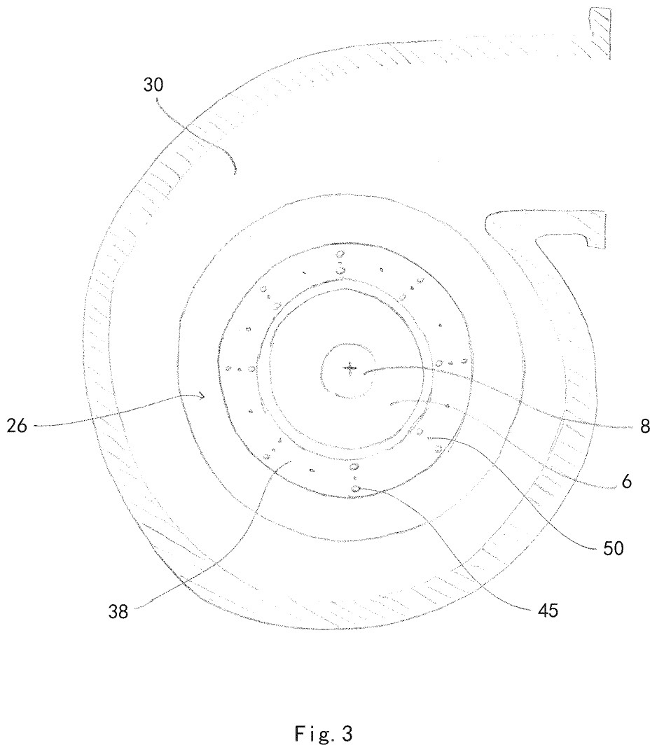

The compressor 2 further comprises a humidification arrangement 32 which is shown in more detail in FIGS. 2 and 3. The humidification arrangement 32 is positioned downstream of the impeller 6 such that it is configured to humidify intake air that has been compressed by the impeller 6. In particular, the humidification arrangement 32 is positioned within the diffuser portion of the compressor housing 4, such that it is able to humidify compressed intake air passing through the diffuser passage 26.

To this end, the humidification arrangement 32 comprises a manifold 34 defined between an annular groove 36 of the compressor housing 4 and a corresponding covering element 38. The covering element 38 is an annularly shaped flat plate. The annular groove 36 of the compressor housing 4 defines a stepped portion 40 which is shaped to receive the covering element 38 such that an outer surface 42 of the covering element 38 sits flush with a corresponding outer surface 44 of the compressor housing 4. The covering element is secured to the compressor housing 4 via a plurality of fixings 45 received by corresponding through holes 47 of the covering element 38 and blind holes 49 of the compressor housing 4. The fixings 45 may be of any suitable variety, for example screws, stakes, rivets or the like. The covering element 38 may be sealed against the stepped portion 40 using a sealing element such as a sealant, gasket, o-ring or the like.

The compressor housing 4 comprises a boss 46 extending outwardly from the exterior of the compressor housing 4 which defines an inlet conduit 48 fluidly connected to the manifold 34. Although not shown, the boss 46 is connected to a source of humidification liquid that is housed in one or more external components to the compressor 2. The external source of humidification liquid may be, for example, a storage tank. Delivery of humidification liquid from the external source may be controlled by a dosing module or the like in communication with the inlet conduit 48. The external source of humidification liquid is preferably pressurised such that it is able to overcome the high pressure of the compressed air within the compressor outlet 22. For example, the humidification liquid may be pressurised to a pressure that is higher than the second pressure p2. Pressurisation may be achieved, for example, by using a pump or the like.

The covering element 38 comprises a plurality of humidification conduits 51 terminating in humidification orifices 50 which extend between opposite sides of the covering element 38 so as to permit fluid communication from the manifold 34 to the diffuser passage 26. During use, humidification liquid, for example water or the like, is received by the inlet conduit 48. The manifold 34 distributes the humidification liquid to the humidification orifices 50, which in turn deliver the humidification liquid to the diffuser passage 26. Because the humidification orifices 50 form part of the compressor 4, there is no need to provide a separate humidifier downstream of the compressor 4, thus leading to overall space and cost savings for the fuel cell system.

Because the humidification orifices 50 are positioned in the compressor outlet 22 (and, in particular, within the diffuser passage 26), this ensures that humidification takes place in a region of high fluid energy. In particular, it will be appreciated that the compressed intake air flowing through the diffuser passage 26 flows at very high velocity and high pressure due to the centrifugal compressing action of the impeller 6. When the humidification liquid enters the diffuser passage 26, it collides with the high velocity intake air, causing atomisation of the humidification liquid into a vapour. Atomisation of the humidification liquid encourages better entrainment of the humidification liquid within the compressed intake air, and promotes a more even distribution of humidification liquid vapour within the compressed intake air. This helps to ensure that the membrane of the fuel cell is evenly exposed to humidity, and mitigates against the formation of localised “dry out” or “flooding” conditions.

As a further advantage, because the humidification orifices are positioned in the compressor outlet 22, this ensures that the humidification fluid does not leak into other parts of the compressor, for example the bearing housing, which may experience component corrosion due to high humidity. Finally, it will be appreciated that the compression of the intake air by the compressor 6 causes the temperature of the intake air to increase. However, when the humidification liquid may be supplied at a lower temperature than the compressed intake air, such that the introduction of the humidification liquid to the compressed intake air lowers the temperature of the compressed intake air. Lowering the temperature of the compressed intake air lowers the saturation pressure of the intake air, and thus causes an increase in relative humidity.

The humidification orifices 50 are distributed evenly around the shaft axis A so as to ensure an even delivery of humidification liquid to the diffuser passage 26. The number, size and distribution of the humidification orifices may be chosen in dependence upon the amount of humidification required to suit the operating conditions of the fuel cell. However, in general it is expected that this number will vary between around 12 to around 20 orifices in total.

The humidification orifices 50 are formed by simple circular through-holes. Such through holes may be parallel to the shaft axis A or may be angled relative to the shaft axis A, for example to impart radial momentum or swirling momentum onto any liquid passing therethrough, which may improve mixing and/or atomisation of the liquid delivered. In some embodiments the humidification orifices 50 may comprise nozzles, for example spray nozzles. The humidification orifices 50 are relatively narrow in diameter, particularly in comparison to the size of the manifold 34. In the present embodiment, the humidification orifices 50 have diameters in the range of around 50 μm to 100 μm. Because the diameters of the humidification orifices are so small, this ensures that the droplets of humidification liquid delivered to the diffuser passage 26 are correspondingly small, so as to encourage the humidification liquid to atomise into a vapour when it collides with the compressed intake air in the diffuser passage 26.

Although the embodiment described above comprises a humidification arrangement 32 having a plurality of humidification orifices 50, it will be appreciated that, in principle, the humidification arrangement may be operable with only a single humidification orifice provided that this is sized and shaped to deliver an adequate amount of humidification liquid to the diffuser passage 26. Whilst the humidification orifices 50 are evenly distributed around the shaft axis A, it will be appreciated that in alternative embodiments the humidification orifices 50 may have any suitable distribution.

Although the groove 36 of the compressor housing 4 and the covering element 38 are generally annular in shape, it will be appreciated that in alternative embodiments the groove 36 and covering element 38 may have any suitable shape. For example, the groove 36 and covering element 38 may extend around the shaft axis A in a non-annular shape, such as an irregular shape or the like. Moreover, the groove 36 and covering element 38 may extend around only a portion of the periphery of the shaft axis A. In some embodiments, multiple manifolds having separate grooves and covering elements may be employed.

Although the covering element 38 described above is formed separately to the compressor housing 4, it will be appreciated that in alternative embodiments the covering element 38 may be integrally formed with the compressor housing. In such embodiments, the covering element may be manufactured, for example, by additive manufacturing. In yet further embodiments, the housing 4 may comprise the groove 32 and covering element 38 as part of a removable sub-assembly.

Whilst the above-described embodiment comprises a humidification arrangement 32 having humidification orifices 50 that are in communication with the diffuser passage 26, it will be appreciated that in alternative embodiments the humidification arrangement and humidification orifices 50 may be in communication with the compressor outlet 30. The velocity of the intake air in the compressor outlet 30 is generally lower than the velocity of the intake air in the diffuser passage 26, and therefore the benefits described above relating to atomisation of the humidification liquid are somewhat lessened compared to the above-described embodiment. However, a larger amount of space is available within the compressor outlet 30 compared to the diffuser passage 26. The increased space available within the compressor outlet 30 may enable mechanisms such as nozzles to be used within the humidification orifices to encourage the formation of a spray could of humidification liquid. By forming a spray using a nozzle, good entrainment and distribution of humidity within the compressed intake air can be ensured.

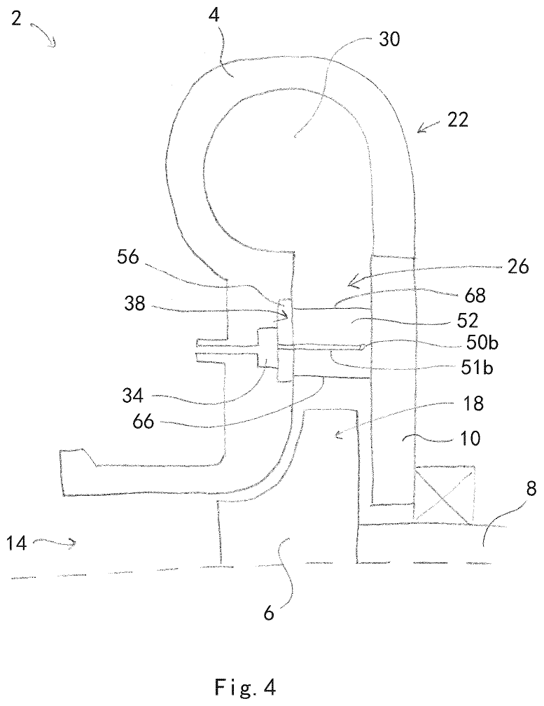

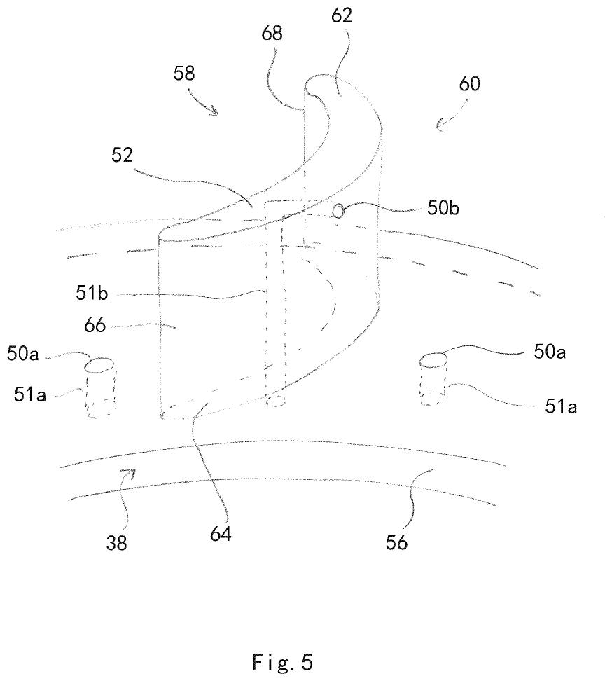

FIGS. 4 and 5 show an alternative embodiment of a compressor 2 according to the present invention. The compressor 2 of FIGS. 4 and 5 is substantially identical to the previously described compressor of FIGS. 1 to 3, aside from the differences set out below. Accordingly, like reference numerals are used to refer to corresponding features of the previous embodiment.

The embodiment of FIGS. 4 and 5 differs from the previous embodiment principally in that the covering element 38 comprises a plurality of diffuser vanes 52 extend axially across the diffuser passage from a base portion 56 of the covering element 38 to the compressor back plate 10. The base portion 56 of the covering element 38 is in the form of a generally annular plate, but may have non-annular constructions as described in relation to the covering element 38 above. The diffuser vanes 52 are configured to expand the compressed intake air in a conventional manner that would be understood to a person skilled in the art. The size, shape, number and distribution of the diffuser vanes 52 will vary in dependence upon the operating parameters of the compressor 2 as would be understood by the skilled person. The covering element 38 comprises two types of humidification conduits and humidification orifices. The first-type humidification conduits 51a extend between opposite sides of the base portion 56 in the same manner as described above in regarding the covering element 38 of the previous embodiment. The first-type humidification conduits terminate in first-type humidification orifices 50a. The second-type humidification conduits 51b extend from the base portion 56 to a distal end 62 of a corresponding vane 52. The distal end 62 is an end of the vane 52 that is positioned away from the base portion 56 on the opposite side of the diffuser passage 26 (the part of the vane 52 that is proximate the base portion 56 may be said to define a proximal end 64). The second-type humidification conduits 51b terminate in second type humidification orifices 50b. The second-type humidification orifices 50b are the same size as the first-type humidification orifices 50a, and in particular may have diameters in the range of around 50 μm to 100 μm. The vanes 52 define leading edges 66 and trailing edges 68. The second-type humidification orifices 50b are positioned approximately half way between the leading edges 66 and the trailing edges 68 in the chord-wise direction (i.e. radial direction relative to shaft axis A). Because the first-type humidification orifices 50a and second-type humidification orifices 50b are positioned on opposite axial sides of the diffuser passage 26, this ensures that the diffuser passage 26 is humidified from both of its axially opposite sides. Consequently, it is possible to achieve a more even distribution of humidification liquid throughout the compressed intake air.

The above notwithstanding, in additional or alternative embodiments, the second-type humidification orifices 50b may be positioned approximately half way between the distal ends 62 and proximal ends 64 of the vanes 52. Accordingly, in such embodiments, the humidification liquid will be delivered into the axial centre of the diffuser passage 26. This may also promote an even distribution of humidification liquid throughout the compressed intake air.

The diffuser vanes 52 comprise pressure sides 58 and suction sides 60. Preferably, the second-type humidification orifices 50b are positioned on the suction sides 60 of the vanes 52. The suction sides 60 will be exposed to a region of relatively low pressure compared to the bulk flow, and this low pressure region may provide a pressure differential that drives delivery of the humidification liquid into the diffuser passage. This ensures better entrainment of the humidification liquid into the compressed intake air and may mitigate the need to pump humidification liquid through the humidification arrangement 32. Although the second-type humidification orifices 50b are positioned on the suction sides 60 of the vanes 52, it will be appreciated that, in general, the second-type humidification orifices 50b may be positioned on the parts of the vanes 52 that are in communication with the regions of lowest local pressure during operation of the compressor 2. The in-use local pressure may be determined, for example, based upon computational fluid dynamics simulations of the compressor.

The above notwithstanding, it will be appreciated that in yet further additional or alternative embodiments, the second-type humidification orifices 50b may be positioned on the pressure sides 58 of the vanes 52. Positioning the humidification orifices 50b on the pressure sides 58 of the vanes 52 ensures that the humidification liquid is delivered to the diffuser passage 26 in a region of high pressure. This may result in improved atomisation of the humidification liquid. Moreover, it will be appreciated that the second-type humidification orifices 50b may be positioned on the parts of the vanes 52 that are in communication with the regions of highest local pressure during operation of the compressor 2. Once again, the in-use local pressure may be determined, for example, based upon computational fluid dynamics simulations of the compressor. Furthermore, the second-type humidification orifices 50b may be configured to deliver the liquid passing therethrough at any suitable angle relative to the pressure surfaces 59 of the vanes 52. For example, the second-type humidification orifices may be angled to impart swirling momentum onto the liquid passing therethrough to improve mixing and/or atomisation.

The diffuser vanes 52 are evenly spaced on a constant pitch circle around the shaft axis A. The first-type humidification orifices 50a are interposed between each pair of vanes 52 at approximately the midpoint therebetween. However, in alternative embodiments, the covering element may comprise only second-type humidification orifices 50b (or only first-type humidification orifices 50a, as per the embodiment of FIGS. 1 to 3). Moreover, it will be appreciated that, in general, humidification orifices, whether these be so-called first-type, second-type or any other type, may be positioned on substantially any part of the covering element 38 such that humidification liquid is delivered to the diffuser passage 26. For example, humidification orifices may be positioned at the leading and/or trailing edges of the diffuser vanes 52. The humidification orifices may be distributed in a line spanning a portion of the diffuser vanes 52, for example chord-wise or span-wise along a portion of vane 52. Although the second embodiment described above comprises only two types of humidification orifice, both of which form part of the covering element 38, it will be appreciated that in further embodiments additional or alternative humidification orifices may be positioned elsewhere in the compressor 2, for example within the volute portion 28 of the compressor housing 4.

Although the covering element 38 of the second embodiment is described as separate to the compressor housing 4, it will be appreciated that in further embodiments the covering element 38 may be integrally formed with the compressor housing 4, such as for example by additive manufacturing. In yet further embodiments, the housing 4 may comprise the groove 32 and covering element 38 as part of a removable sub-assembly.

Moreover, with respect to either of the embodiments above, it will be appreciated that the covering element 38 may be any suitable size or shape provided that it is capable of covering the groove 36. In particular, the covering element 38 need not be a flat plate, but may comprise one or more raised or partially conical surfaces, for example to define a venturi within the diffuser passage 26.

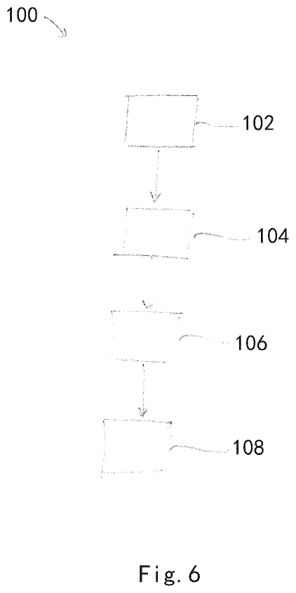

FIG. 6 shows a method 100 according to the present invention of humidifying and compressing a gas in a fuel cell system. In a first step 102 of the method 100, ambient pressure gas is received into an inlet of a compressor at a first pressure p1. The gas may be, for example, atmospheric air. Accordingly, the first pressure p1 may be equal to atmospheric pressure. In a second step 104 of the method 100, the ambient pressure gas is compressed using a compressor to a second pressure p2 to produce compressed gas. The second pressure p2 is higher than the first pressure p1. In a third step 106 of the method 100, a humidification liquid is delivered to the compressed gas via a humidification arrangement positioned within an outlet of the compressor to produce humidified compressed gas. Any suitable compressor may be used, however it will be appreciated that a compressor 2 according to any one of the previously described embodiments set out above is well-suited for this purpose since the humidification arrangements 32 are positioned fluidly downstream of the compressing means (the impeller 6). Accordingly, the humidification arrangement of step 106 may be, in particular, any one of the humidification arrangements 32 described above in relation to the previous embodiments. Because humidification takes place within the compressor and at a position within the compressor outlet it will be appreciated that the same advantages described above in relation to the first and second embodiments of the compressor 2 apply equally to the method 100. Finally, in a last step 108 of the method 100, the humidified compressed gas is delivered to an inlet of a fuel cell.

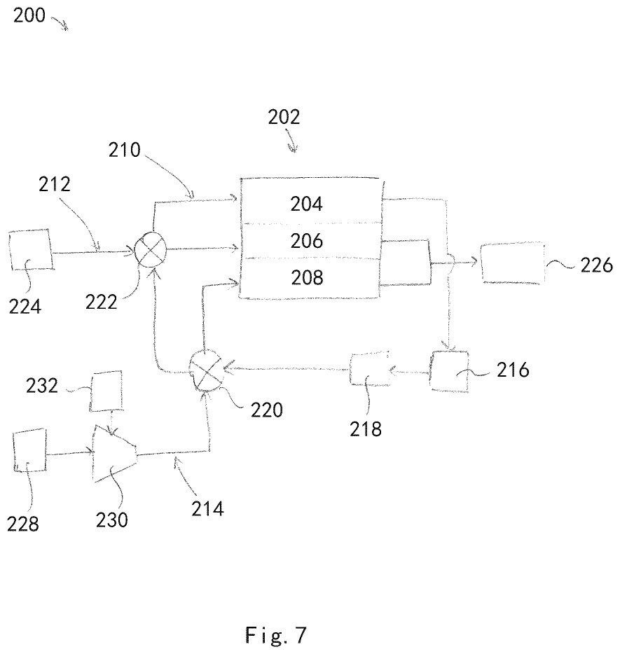

FIG. 7 shows a schematic system diagram of a fuel cell system 200 according to the present invention. The fuel cell system 200 comprises a fuel cell 202 having a cooling device 204, an anode 206 and a cathode 208. The fuel cell may be a proton-exchange membrane (PEM) fuel cell. The fuel cell 202 is connected to an electrical load (not shown), which may be, for example, an electric motor of a vehicle. The fuel cell system comprises a coolant circuit 210, a fuel circuit 212, and an oxidant circuit 214.

The coolant circuit 212 comprises coolant fluid that passes through the coolant device 204. The coolant fluid will be heated in the coolant device 204 by the fuel cell 202 during use. An outlet of the coolant device 204 is fluidly connected to a radiator 216 configured to cool the coolant fluid. The coolant fluid is then passed to a pump 218, and onwards through a first heat exchanger 220 and a second heat exchanger 222 before returning to the coolant device 204.

The fuel circuit 212 comprises a fuel storage tank 224 comprising a fuel, such as hydrogen. The fuel storage tank is fluidly connected to the second heat exchanger 222, which in turn passes the fuel to the anode of the fuel cell 202. From the anode 202, waste fuel is passed to an exhaust 226, where it may be vented to atmosphere.

The oxidant circuit 214 comprises an air filter 228 which receives intake air from the atmosphere. The filter 228 is configured to remove particles from the intake air. The intake air is passed to a compressor 230. The compressor 230 receives a humidification liquid from a humidification liquid source 232. The compressor 230 is, in particular, a compressor according to any one of the embodiments described above in relation to FIGS. 1 to 5. The outlet of the compressor 230 is connected to the first heat exchanger 220, which is configured to cool the compressed intake air. The compressed intake air is then passed to the cathode 208 of the fuel cell 202 and onwards to the exhaust 226.

1. A compressor housing for a compressor of a fuel cell system, the compressor housing comprising:
an inlet portion defining a compressor inlet configured to receive intake air, an impeller chamber portion at least partially defining an impeller chamber in fluid communication with the compressor inlet; and
an outlet portion at least partially defining a compressor outlet in fluid communication with the impeller chamber;
wherein the outlet portion at least partially defines a humidification arrangement configured to deliver a humidification liquid to the compressor outlet.

2. The compressor housing according to claim 1, wherein the outlet portion of the compressor housing at least partially defines a diffuser portion in communication with the impeller chamber, the diffuser portion at least partially defining the humidification arrangement.

3. The compressor housing according to claim 2, wherein the humidification arrangement comprises at least one of:
a manifold defined between the diffuser portion of the compressor housing and a covering element; and
an inlet in fluid communication with the manifold and configured to receive humidification liquid from an external source.

4. The compressor housing according to claim 3, wherein the compressor housing comprises a peripherally extending groove having a stepped portion configured to receive the covering element.

5. (canceled)

6. The compressor housing according to claim 3, wherein the compressor housing defines a compressor axis, and wherein the manifold peripherally surrounds the compressor axis.

7. The compressor housing according to claim 6, wherein the manifold is defined by an annular groove centred on the compressor axis.

8. A compressor housing assembly comprising:
the compressor housing of claim 3; and
a covering element configured for receipt within the channel,
wherein the covering element comprises a humidification orifice configured to permit fluid communication from the channel to the diffuser.

9-20. (canceled)

21. A compressor comprising the compressor housing of claim 1.

22. A fuel cell system comprising:
a fuel cell inlet configured to receive intake air from the atmosphere;
a compressor according to claim 21, the compressor inlet being in communication with the fuel cell inlet to receive intake air;
a heat exchanger in communication with the compressor outlet, the heat exchanger being configured to extract heat from the compressed intake air; and
a fuel cell in communication with the heat exchanger to receive compressed intake air.

23. (canceled)

24. A covering element for a humidification arrangement of a compressor housing, the covering element comprising a humidification orifice configured to permit fluid communication from a manifold of the humidification arrangement to a diffuser passage of a compressor of which the compressor housing forms part.

25. The covering element according to claim 24, wherein the covering element comprises an annular plate configured for receipt within an annular groove of the humidification arrangement.

26. The covering element according to claim 25, wherein the annular plate comprises the humidification orifice.

27. The covering element according to claim 26, wherein the covering element comprises a plurality of humidification orifices.

28. The covering element according to claim 27, wherein the covering element defines a central axis, and wherein the plurality of humidification orifices are equispaced around the central axis.

29. The covering element according to claim 28, wherein the covering element comprises a base portion and a diffuser vane extending from the base portion in an axial direction relative to the central axis.

30. The covering element according to claim 29, wherein the diffuser vane comprises the humidification orifice.

31. The covering element according to claim 30, wherein the diffuser vane comprises a pressure side and a suction side, and wherein at least one of: the suction side comprises the humidification orifice and the pressure side comprises the humidification orifice.

32. The covering element according to claim 30, wherein the humidification orifice is positioned at a point on the diffuser vane in communication with the region of lowest local pressure during use of a compressor within which the covering element forms part.

33. (canceled)

34. The covering element according to claim 30, wherein the diffuser vane defines either:
a proximal end and a distal end relative to the base portion, and wherein the humidification orifice is positioned generally halfway between the proximal and distal ends or
a leading edge and a trailing edge, and wherein the humidification port is positioned generally halfway between the leading edge and the trailing edge.

35. (canceled)

36. A method of compressing and humidifying a gas in a fuel cell system, the method comprising:
receiving ambient pressure gas at a first pressure into an inlet of a compressor;
compressing the ambient pressure gas using the compressor to a second pressure, higher than the first pressure to produce compressed gas;
delivering a humidification liquid to the compressed gas via a humidification arrangement positioned within an outlet of the compressor to produce humidified compressed gas; and
delivering the humidified compressed gas to an inlet of a fuel cell.

37. (canceled)
